(19) United States
(12) Patent Application Publication
(10) Pub. No.: US 2012/0124477 A1
(43) Pub. Date: May 17, 2012

(54) Alerting users to personalized information

(75) Inventors: Timothy Edgar, Bellevue, WA (US); Igor Avramovic, Kirkland, WA (US)

(73) Assignee: Microsoft Corporation, Redmond, WA (US)

(21) Appl. No.: 12/943,952

(22) Filed: Nov. 11, 2010

(51) Int. Cl. G06F 3/048; G06F 15/16

(52) U.S. Cl. 715/738

(57) ABSTRACT

The claimed subject matter provides a system and/or method for alerting users to personalized information. An exemplary method comprises storing information relating to a subscription to an alert type from a content provider. An alert of the alert type may be received from the content provider and added to a queue. Alerts may be prioritized relative to other alerts within the queue and then rendered from the queue in order of priority to a user.

### BACKGROUND

Browsers are software applications that allow users to communicate with the World Wide Web, including the Internet. In particular, one function provided by a browser is to allow a user to access websites of interest. The browser may employ an application commonly known as a browser toolbar. A browser toolbar typically provides access to a set of functions that may be considered convenient by the user. Buttons or other access mechanisms may be used in a toolbar to allow a user to access the functions that it provides. Examples of functions that may be grouped together in a browser toolbar include a search function, and access to services such as weather and news feeds that may be desired by the user.

Many toolbars are customizable by the user so that they may provide access to specific functions of interest to the user. Browser toolbars may additionally display information from a particular website while the user is visiting the website.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to a method and a system for alerting users to personalized information. An exemplary method comprises storing information relating to a subscription to an alert type from a content provider. An alert of the alert type may be received from the content provider and added to a queue. Alerts may be prioritized relative to other alerts within the queue and then rendered from the queue in order of priority to a user.

An exemplary system alerts users to personalized information in browser toolbars and renders the notifications on an output device. One exemplary system comprises a processing unit and a system memory. The memory system, which comprises a computer-readable storage medium, stores code configured to direct the processing unit to store information relating to a subscription to an alert type from a content provider. Also stored in the system memory is code to direct the processing unit to receive an alert of the alert type from the content provider and add the alert to a queue. Code stored in the system memory may also be configured to cause the processing unit to prioritize alerts relative to other alerts within the queue and then render alerts from the queue in order of priority to a user.

Another exemplary embodiment of the subject innovation provides one or more computer-readable storage media that includes code to direct the operation of a processing unit. The code may direct the processing unit to alert users to personalized information in browser toolbars. The computer-readable storage media may comprise code that could direct a processing unit to store information relating to a subscription to an alert type from a content provider. Code stored on the computer-readable storage media may include code configured to receive an alert of the alert type from the content provider and add the alert to a queue. In addition, code stored on the computer-readable storage media may be configured to prioritize alerts relative to other alerts within the queue and then render alerts from the queue in order of priority to a user.

The following description and the annexed drawings set forth in detail certain illustrative aspects of the claimed subject matter. These aspects are indicative, however, of but a few of the various ways in which the principles of the innovation may be employed, and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of an exemplary user interface wherein aspects of the claimed subject matter can be employed;

FIG. 2 is a block diagram of an exemplary user interface wherein aspects of the claimed subject matter can be employed;

FIG. 3 is a block diagram of an exemplary user interface wherein aspects of the claimed subject matter can be employed;

FIG. 4 is a process flow diagram of a method for alerting users to personalized information in browser toolbars according to the subject innovation;

FIG. 5 is a block diagram of an exemplary networking environment wherein aspects of the claimed subject matter can be employed; and

FIG. 6 is a block diagram of an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “browser,” “toolbar,” and the like are intended to refer to a computer-related entity, either hardware, software (e.g., in execution), and/or firmware. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media, such as a computer-readable storage media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for electrical or electronic signals and the like.

Those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

The subject innovation relates to a method and a system for alerting users to personalized information in browser toolbars. The user determines what personalized information is sent to the user via the browser toolbar. This information is rendered to the user in a format referred to as an alert in a noticeable yet subtle manner. The subject innovation is capable of pushing this information to the user without keeping the website open in a tab at all times.

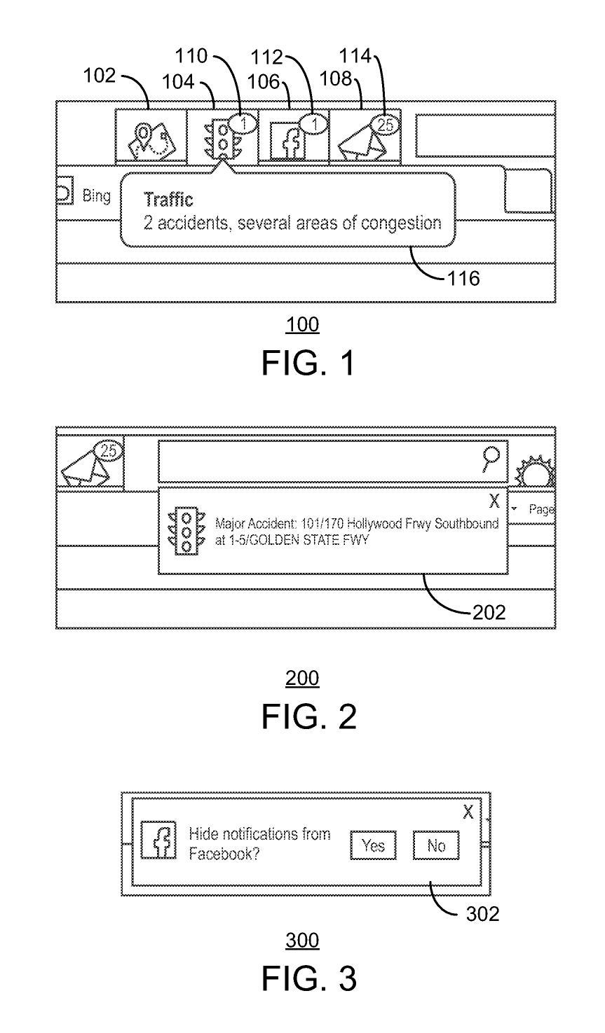

FIG. 1 is a block diagram of an exemplary user interface wherein aspects of the claimed subject matter can be employed. The user interface 100 may be a component or portion of a toolbar such as the Bing™ Bar provided by Microsoft Corporation, which may allow users to subscribe to receive alerts from various content providers. Generally speaking, alerts from these content providers may be represented by logos indicative of their source. The user interface 100 shows a button 102, a traffic data alert 104, a social networking alert 106, and an email alert 108. The alerts provided by the content providers may be rendered on the condition that the user has agreed to receive alerts from each content provider. Alerts may be rendered one at a time. The content providers shown in user interface 100 are meant to be merely illustrative and not exhaustive.

Alerts from each content provider may be monitored by an exemplary embodiment of the subject innovation and queued through a central processing system. All alerts may be displayed in order of priority. In an exemplary embodiment, alert priority is determined by ranking alerts according to the relative importance of the subject matter of the alerts. For example, a weather alert notifying the user of a tornado warning has a higher level of priority than an email alert. The user's current activity and browsing history may also be a factor in prioritizing alerts. In the case of a user that frequently visits social networking websites and visits sports websites less frequently, the social networking alerts may have a higher priority than the sports alerts. A toolbar according to an exemplary embodiment may have default settings for relative importance of alerts, which may be modified by a user.

A toolbar according to an exemplary embodiment may render pending alerts with numerals in addition to the standard logo for the alert. The pending alerts may have been “missed” by the user. A missed alert may be one that with which the user did not engage or have significant “hover” time. Hovering over an alert may involve using the mouse to place the cursor over the alert without clicking on the alert. A missed alert may also be an alert that is never displayed to the user and times-out in the queue. Each pending alert may be saved for rendering at a later time. In one exemplary embodiment, missed alerts are saved until display of missed alerts is requested by the user. As explained herein, the user may request missed alerts to be displayed by hovering over a logo corresponding to an alert type that has been subscribed to by the user.

The traffic data alerts 104, social networking alerts 106, and email alerts 108 each show a numeral in the upper right quadrant of the respective logo that denotes the alert. For example, traffic data alert 104 has a numeral indicator 110 in the upper right quadrant that indicates one pending traffic data alert 104. Similarly, the social networking alert 106 has a numeral indicator 112 in the upper right quadrant that indicates one pending social networking alert 106. The email alert 108 has a numeral indicator 114 that indicates twenty-three pending email alerts 108. Pending alerts identified by the numeral indicators 110, 112 and 114 may have been missed or not acted on by the user. Indicators may have other formats in addition to being numeric. For example, an indicator with a lock image may represent a security related message. An indicator with a star image may represent a special message. As explained herein, pending alerts may be viewed upon request by the user. In one example, the user requests to view pending alerts by hovering over an icon corresponding to an alert type that has been subscribed to by the user.

When there is a pending alert, the user can manipulate the mouse to hover over the pending alert. While the user hovers over a pending alert, a “hover preview” occurs. The hover preview provides a short, succinct statement regarding the missed alerts. The user interface 100 shows an exemplary hover preview 116 of a traffic data alert 104. The hover preview 116 disappears when the user moves the cursor away from the alert.

FIG. 2 is a block diagram of an exemplary user interface wherein aspects of the claimed subject matter can be employed. The user interface 200 may also be a component or portion of a toolbar such as the Bing™ Bar provided by Microsoft Corporation. The user interface 200 displays an alert 202, which may be initially rendered in a translucent state. Without interaction from the user, the alert may stay at the translucent state for a short period of time before it slowly fades away and disappears. The number of pending alerts for the particular type of alert that was added to the queue may be updated after the alert disappears without user interaction.

In response to interaction by a user, such as hovering over the translucent alert (for example, with a pointing device such as a mouse or the like), the alert may immediately become interactable and opaque. If the user clicks on an alert, the user may be led to a default action associated with the alert. Typically, the default action associated with each alert is to learn more about the topic of the alert. For example, alert 202 alerts the user to a major traffic accident. The user can click within the alert window to find out more information regarding the accident. As a result of the user clicking within the alert window, the web browser may navigate to a webpage that possesses more information regarding the traffic accident. This information may include, for example, the length of time the accident has been on the road, time of delay for travelers on that road, and alternate travel routes.

In one exemplary embodiment, the user can subscribe to alerts through contextual notifications. For example, the user may select a contextual notification and subscribe to receive alerts similar to the contextual notification. Based on the subscription, the user may add a button to a toolbar such as the Bing™ Bar provided by Microsoft Corporation. Additionally, the user may add a toolbar application to the browser as a result of subscribing to alerts through a contextual notification. The new toolbar application may be represented by a new button on the toolbar. The new button enables new functionality within the existing toolbar. After subscription, the alerts have their own user interface when clicked, where the user is able to see a short history of alerts that have previously been rendered.

FIG. 3 is a block diagram of an exemplary user interface wherein aspects of the claimed subject matter can be employed. The user interface 300 may also be a component or portion of a toolbar such as the Bing™ Bar provided by Microsoft Corporation. The user interface 300 provides an example of how alerts received according to an exemplary embodiment may be managed. Moreover, an exemplary embodiment of the subject innovation may be configured to throttle the amount of alerts to the user. For example, when a user closes a particular alert a specific number of times (e.g., three times), the user may be asked if they would like to hide the particular type of alert. If the user chooses to hide the alert, then any future alerts of that particular type will be hidden from the user. Alerts may be managed through toolbar settings, where he user is able to customize the alerts received by choosing which alert to render in the toolbar settings. The alert management 302 shows the user interface for managing alerts.

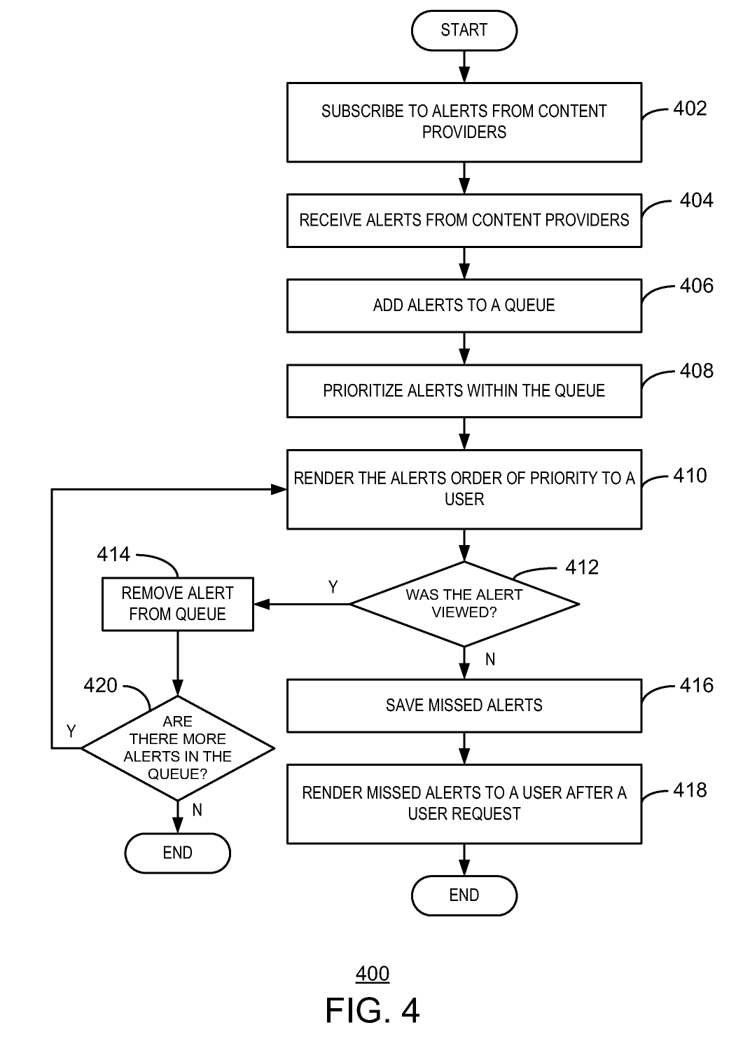

FIG. 4 is a process flow diagram of a method 400 for alerting users to personalized information in browser toolbars according to the subject innovation. At block 402, the user may subscribe to alerts from content providers. The subscription to alerts may occur through contextual notifications or the user may subscribe to the alerts within the toolbar settings, or by other methods. At block 404, the user receives alerts from the selected content providers.

At block 406, the alerts from the content providers are added to a queue. The alerts are prioritized in order of importance within the queue at block 408. At block 410, the alerts are rendered, for example, in a visually translucent state to the user. The alerts may be rendered in order of priority. The alert 202 (FIG. 2) shows an alert rendered in a visually translucent state. At block 412, a determination is made regarding whether the user viewed the alert. If the user viewed the alert, the alert is removed from the queue at block 414 and process flow continues to block 420. If the user did not view the alert, the alert is classified as pending and saved at block 416. An indicator that an alert has been saved (for example, a numerical indicator) is placed in the upper right quadrant of the alert logo. If a numerical indicator is used, it informs the user of the particular number of alerts pending for the particular alert type. In the example shown in FIG. 1, numeral indicators 110, 112, and 114 (FIG. 1) show the number of pending alerts for the traffic data alert 104, social networking alert 106, and email alert 108 (FIG. 1), respectively. At block 418, the missed alerts are rendered after a user request. A user request may be carried out by the user clicking on the alert logo that contains pending alerts.

At block 420, a determination is made regarding whether there are more alerts in the queue. If there are more alerts in the queue, process flow resumes at block 410. If there are no alerts in the queue, the method 400 ends.

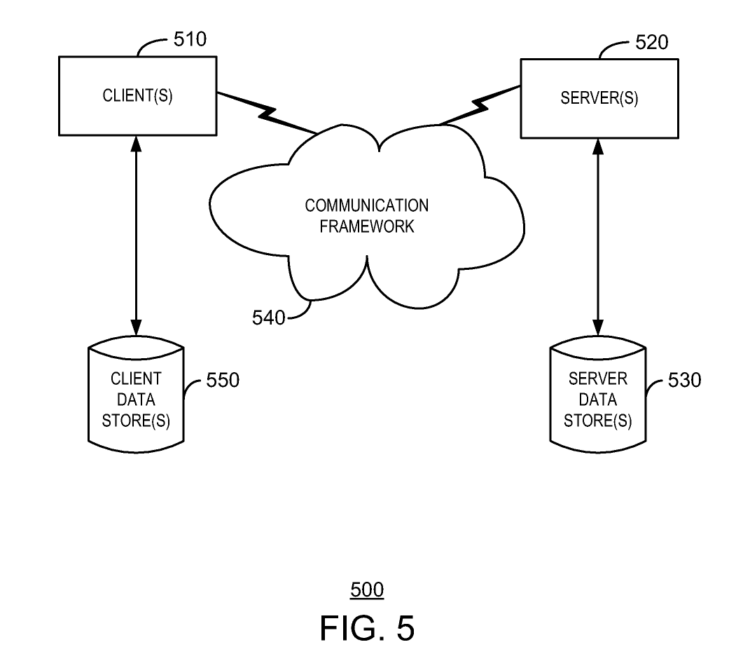

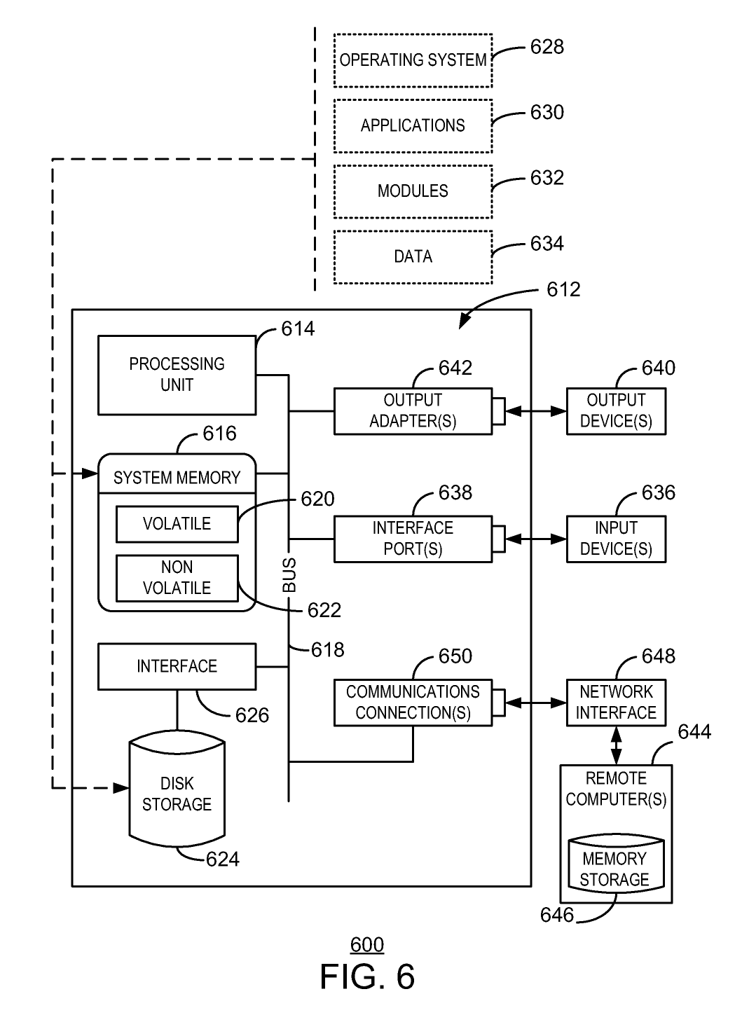

In order to provide additional context for implementing various aspects of the claimed subject matter, FIGS. 5-6 and the following discussion are intended to provide a brief, general description of a suitable computing environment in which the various aspects of the subject innovation may be implemented. For example, alerts, as described herein, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the subject innovation may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 5 is a schematic block diagram of a sample-computing system 500 with which the claimed subject matter can interact. The system 500 includes one or more client(s) 510. The client(s) 510 can be hardware and/or software (e.g., threads, processes, computing devices). The system 500 also includes one or more server(s) 520. The server(s) 520 can be hardware and/or software (e.g., threads, processes, computing devices). The server(s) 520 may include the queue of alerts as discussed herein.

One possible communication between a client 510 and a server 520 can be in the form of an alert adapted to be transmitted between two or more computer processes. The system 500 includes a communication framework 540 that can be employed to facilitate communications between the client(s) 510 and the server(s) 520. The client(s) 510 are operably connected to one or more client data store(s) 550 that can be employed to store information local to the client(s) 510. The client data store(s) 550 do not have to be in the client(s) 510, but may be located remotely, such as in a cloud server. Similarly, the server(s) 520 are operably connected to one or more server data store(s) 530 that can be employed to store information local to the servers 520.

As an example, the client(s) 510 may be computers providing access to websites over a communication framework 540, such as the Internet. The server(s) 520 may be able to monitor web services accessed by the client as well as queue the user-subscribed alerts in priority order.

With reference to FIG. 6, an exemplary environment 600 for implementing various aspects of the claimed subject matter includes a computer 612. The computer 612 includes a processing unit 614, a system memory 616, and a system bus 618. The system bus 618 couples system components including, but not limited to, the system memory 616 to the processing unit 614. The processing unit 614 can be any of various available processors. Dual microprocessors and other multiprocessor architectures also can be employed as the processing unit 614.

The system bus 618 can be any of several types of bus structure(s) including the memory bus or memory controller, a peripheral bus or external bus, and/or a local bus using any variety of available bus architectures known to those of ordinary skill in the art.

The system memory 616 may comprise non-transitory computer-readable storage media that includes volatile memory 620 and nonvolatile memory 622. The basic input/output system (BIOS), containing the basic routines to transfer information between elements within the computer 612, such as during start-up, is stored in nonvolatile memory 622. By way of illustration, and not limitation, nonvolatile memory 622 can include read only memory (ROM), programmable ROM (PROM), electrically programmable ROM (EPROM), electrically erasable programmable ROM (EEPROM), or flash memory.

Volatile memory 620 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 612 also includes other non-transitory computer-readable media, such as removable/non-removable, volatile/non-volatile computer storage media. FIG. 6 shows, for example a disk storage 624. Disk storage 624 includes, but is not limited to, devices like a magnetic disk drive, floppy disk drive, tape drive, Jaz drive, Zip drive, LS-100 drive, flash memory card, or memory stick.

In addition, disk storage 624 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 624 to the system bus 618, a removable or non-removable interface is typically used such as interface 626.

It is to be appreciated that FIG. 6 describes software that acts as an intermediary between users and the basic computer resources described in the suitable operating environment 600. Such software includes an operating system 628. Operating system 628, which can be stored on disk storage 624, acts to control and allocate resources of the computer system 612.

System applications 630 take advantage of the management of resources by operating system 628 through program modules 632 and program data 634 stored either in system memory 616 or on disk storage 624. It is to be appreciated that the claimed subject matter can be implemented with various operating systems or combinations of operating systems.

A user enters commands or information into the computer 612 through input device(s) 636. Input devices 636 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 636 connect to the processing unit 614 through the system bus 618 via interface port(s) 638. Interface port(s) 638 include, for example, a serial port, a parallel port, a game port, and a universal serial bus (USB).

Output device(s) 640 use some of the same type of ports as input device(s) 636. Thus, for example, a USB port may be used to provide input to the computer 612, and to output information from computer 612 to an output device 640.

Output adapter 642 is provided to illustrate that there are some output devices 640 like monitors, speakers, and printers, among other output devices, which are accessible via adapters. The output adapters 642 include, by way of illustration and not limitation, video and sound cards that provide a means of connection between the output device 640 and the system bus 618. It can be noted that other devices and/or systems of devices provide both input and output capabilities such as remote computer(s) 644.

The computer 612 can be a server hosting a central alerting system in a networked environment using logical connections to one or more remote computers, such as remote computer(s) 644. The remote computer(s) 644 may be client systems configured with web browsers, PC applications, mobile phone applications, and the like, to allow users to access the social networking site, as discussed herein. The remote computer(s) 644 can be a personal computer, a server, a router, a network PC, a workstation, a microprocessor based appliance, a mobile phone, a peer device or other common network node and the like, and typically includes many or all of the elements described relative to the computer 612. For purposes of brevity, only a memory storage device 646 is illustrated with remote computer(s) 644. Remote computer(s) 644 is logically connected to the computer 612 through a network interface 648 and then physically connected via a communication connection 650.

Network interface 648 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 650 refers to the hardware/software employed to connect the network interface 648 to the bus 618. While communication connection 650 is shown for illustrative clarity inside computer 612, it can also be external to the computer 612. The hardware/software for connection to the network interface 648 may include, for exemplary purposes only, internal and external technologies such as, mobile phone switches, modems including regular telephone grade modems, cable modems and DSL modems, ISDN adapters, and Ethernet cards.

An exemplary embodiment of the computer 612 may comprise a server hosting a central alerting system. An exemplary processing unit 614 for the server may be a computing cluster comprising Intel® Xeon CPUs. The disk storage 624 may comprise an enterprise data storage system, for example, holding thousands of user pages. Exemplary embodiments of the subject innovation may provide user-subscribed alerts as described herein.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

1. A method for alerting users to personalized information, the method comprising:
storing information relating to a subscription to an alert type from a content provider;
receiving an alert of the alert type from the content provider;
adding the alert to a queue;
prioritizing the alert relative to other alerts within the queue; and
rendering alerts from the queue in order of priority to a user.

2. The method recited in claim 1, comprising:
saving missed alerts; and
rendering the missed alerts to the user after a user request.

3. The method recited in claim 1, wherein the alerts are rendered in a visually translucent state.

4. The method recited in claim 3, wherein the alert gradually disappears without any interaction from the user.

5. The method recited in claim 3, wherein the alert immediately becomes opaque in response to interaction from the user.

6. The method recited in claim 1, wherein prioritizing the alert is performed based on a default setting.

7. The method recited in claim 1, wherein prioritizing the alert is performed based on a user-defined setting.

8. The method recited in claim 1, comprising rendering a history of alerts previously rendered responsive to user interaction with the alert.

9. The method recited in claim 1, comprising rendering an indicator to signify a number of missed alerts.

10. The method recited in claim 1, comprising receiving a request from a user to suppress alerts of a particular type.

11. The method recited in claim 1, comprising providing the user with more information about the alert in response to user interaction with the alert.

12. A system for issuing behavioral and contextual notifications, the system comprising:
a processing unit; and
a system memory, wherein the system memory comprises code configured to direct the processing unit to:
store information relating to a subscription to an alert type from a content provider;
receive an alert of the alert type from the content provider;
add the alert to a queue;
prioritize the alert relative to other alerts within the queue; and
render alerts from the queue in order of priority to a user.

13. The system recited in claim 12, comprising:
saving missed alerts; and
rendering the missed alerts to the user after a user request.

14. The system recited in claim 12, wherein prioritizing the alert is performed based on a default setting or a user-defined setting.

15. The system recited in claim 12, comprising rendering a history of alerts previously rendered responsive to user interaction with the alert or rendering an indicator to signify a number of missed alerts.

16. The system recited in claim 12, comprising receiving a request from a user to suppress alerts of a particular type or providing the user with more information about the alert in response to user interaction with the alert.

17. One or more computer-readable storage media, comprising code configured to direct a processing unit to:
store information relating to a subscription to an alert type from a content provider;
receive an alert of the alert type from the content provider;
add the alert to a queue;
prioritize the alert relative to other alerts within the queue; and
render alerts from the queue in order of priority to a user.

18. The one or more computer-readable storage media recited in claim 17, comprising:
saving missed alerts; and
rendering the missed alerts to the user after a user request.

19. The one or more computer-readable storage media recited in claim 17, wherein prioritizing the alert is performed based on a default setting or a user-defined setting.

20. The one or more computer-readable storage media recited in claim 17, comprising receiving a request from a user to suppress alerts of a particular type or providing the user with more information about the alert in response to user interaction with the alert.
